(19) United States
(12) Patent Application Publication
(10) Pub. No.: US 2011/0002150 A1
(43) Pub. Date: Jan. 6, 2011

(54) Rectifier Circuit with High Efficiency

(75) Inventors: Hoi-Jun Yoo, Daejeon (KR); Jerald Yoo, Daejeon (KR)

Correspondence Address: PRYOR CASHMAN, LLP, 7 Times Square, NEW YORK, NY, 10036-6569, US

(73) Assignee: Korea Advanced Institute of Science and Technology, Daejeon (KR)

(21) Appl. No.: 12/626,350

(22) Filed: Nov. 25, 2009

(30) Foreign Application Priority Data
Jul. 6, 2009 (KR) 10-2009-0061029

(51) Int. Cl. H02M 7/217

(52) U.S. Cl. 363/127

(57) ABSTRACT

Disclosed is a rectifier circuit in order to adaptively reduce a threshold voltage of a diode module constituting the rectifier circuit using an output voltage of the rectifier circuit. A PMOS diode module flowing the forward current from an input terminal to an output terminal comprises: a first PMOS transistor including a source and a drain connected to the input terminal and the output terminal, respectively; a second PMOS transistor including a source connected to the output terminal, and a gate and a drain connected to each other; a switch connecting the gate of the first PMOS transistor to one of the output terminal and the drain of the second PMOS transistor; and a bias resistor including one terminal connected to the gate of the second PMOS transistor and another terminal to which a bias voltage is applied.

### BACKGROUND OF THE INVENTION

1. Field of the Invention

The present invention relates to a rectifier circuit.

2. Description of the Related Art

A rectifier circuit is a circuit converting an alternating current (AC) signal into a direct current (DC) signal. The rectifier circuit is widely used for most products including electronic components such as fluorescent light lamps or vehicles using electric energy. In particular, in recent years, research into wireless power transmission technology has been actively performed. In the wireless transmission technology, to restore and use power transmitted via a wireless line to a source voltage, it should be converted into a DC value. In this case, a main circuit is the rectifier circuit.

The higher conversion efficiency is, the better the rectifier circuit is. Namely, in an input AC signal having the same magnitude, the greater a magnitude of an output DC signal is, the lower the conversion loss is. Accordingly, efficiency of the rectifier circuit is higher. Recently, many enterprises or research institutions have been studying products with high energy efficiency. In general, the higher efficiency of the rectifier circuit producing a source voltage is, the higher the efficiency of a total system is.

A main factor reducing efficiency of the rectifier is a threshold voltage of a diode included therein. FIG. 1 is a circuitry diagram illustrating a conventional half wave rectifier. A first transistor TR1 is connected to an input terminal and an output terminal to be operated as a diode. In the present specification, it is assumed that a transistor is diode-connected when it is connected to an input terminal and an output terminal to be operated as a diode. In the same manner, a second transistor TR2 is diode-connected. When an AC wave is input to the input terminal, the first diode-connected transistor TR1 should be turned-on to flow a forward current to the output terminal. To do this, a gate voltage of the first transistor TR1 should be greater than a threshold voltage of the first transistor TR1. In a rectifier circuit of FIG. 1, when it is assumed that a sine wave is input thereto, so as to flow a forward current from an input terminal to an output terminal, a first diode-connected transistor TR1 should be turned-on. In order to do this, a gate voltage of the first transistor TR1 should be greater than a threshold voltage Vₜₕ of the first transistor TR1. In other words, when a positive magnitude of an input signal to the rectifier circuit is Vᵢₙ, a voltage used for rectification is only Vᵢₙ−Vₜₕ. Only Vth of an input signal consumes power to substantially turn-on the first transistor TR1.

Although it is not shown, if a full wave rectifier is constructed in the same way as in the half wave rectifier of FIG. 1, even though an input signal has a negative value, a voltage consumes power to turn-on a diode-connected transistor. Accordingly, when an amplitude of the input voltage is Vin, a maximum output voltage is 2(Vᵢₙ−Vₜₕ), and a real output voltage becomes lower than 2(Vᵢₙ−Vₜₕ) due to leakage and the like. When a full wave rectifier is constructed in the same way as in the half wave rectifier of FIG. 1, FIG. 2 indicates relationship between an input voltage and an output voltage. A Vₜₕ part 20 of the input signal Vᵢₙ in FIG. 2 is not used to increase the output signal.

Several approaches have been pursued in the art to attempt to solve low efficiency problems of the rectifier circuit. The most widely used prior art method to increase efficiency is to use a diode such as a Schottky diode with a low threshold voltage. Since the Schottky diode has a lower threshold voltage as compared with a PN junction diode, energy loss is reduced at the time of conversion. However, because the Schottky diode cannot be provided by a general CMOS process, the cost is expensive. Accordingly, upon using the Schottky diode, this results in an increase of manufacturing cost in a product.

FIG. 3 is a view illustrating a conventional rectifier circuit removing loss due to a threshold voltage without using a special process using the Schottky diode as another attempt improving efficiency of a rectifier circuit. A separate battery is connected to a gate of diode-connected transistors TR1 and TR2. In this case, the separate battery has an output voltage V_{bt} equal to or greater than a threshold voltage Vₜₕ of a corresponding transistor. Accordingly, a voltage loss in first and second transistors TR1 and TR2 is scarcely caused by a threshold voltage. Consequently, when an input having amplitude of ±Vᵢₙ is received, an output voltage theoretically increases to 2Vᵢₙ unlike in a case of FIG. 1. However, a method of FIG. 3 has a disadvantage that a power source such as a separate battery should be included in the rectifier circuit. This complicates the production and increases manufacturing costs.

### SUMMARY OF THE INVENTION

The present invention has been made in view of the above problems, and it is an object of the present invention to provide a rectifier circuit that gets high rectification efficiency and does not need an external power source.

In accordance with an exemplary embodiment of the present invention, there is provided a PMOS diode module flowing a forward current from an input terminal to an output terminal, comprising: a first PMOS transistor including a source connected to the input terminal, and a drain connected to the output terminal; a second PMOS transistor including a source connected to the output terminal, and a gate and a drain connected to each other; a switch connecting the gate of the first PMOS transistor to one of the output terminal and the drain of the second PMOS transistor; and a bias resistor including one terminal connected to the gate of the second PMOS transistor and another terminal to which a bias voltage is applied.

In accordance with another embodiment of the present invention, there is provided an NMOS diode module flowing a forward current from an input terminal to an output terminal comprising: a first NMOS transistor including a drain connected to the input terminal, and a source connected to the output terminal; a second NMOS transistor including a drain connected to the gate of the first NMOS transistor, and a gate and a drain connected to each other; a switch connecting the gate of the first NMOS transistor to one of the output terminal and the drain of the second PMOS transistor; and a bias resistor including one terminal connected to the gate of the second NMOS transistor and another terminal to which a bias voltage is applied.

In accordance with another aspect of the present invention, there is provided a rectifier circuit receiving and rectifying differential signals through a first input terminal and a second terminal, and outputting the rectified differential signals to an output terminal, comprising:

first to fourth diode modules each including an input terminal, an output terminal, and a control input terminal,

wherein the output terminal of the second diode module is connected to the input terminal of the first diode module,

the output terminal of the fourth diode module is connected to the input terminal of the third diode module, the input terminal of the first diode module is connected to the first input terminal, the input terminal of the third diode module is connected to the second input terminal, the output terminal of the first diode module and the output terminal of the third diode module are connected to the output terminal of the rectifier circuit, the input terminal of the second diode module and the input terminal of the fourth diode module are connected to each other to constitute a ground voltage terminal, the first and third diode modules each is constructed by the PMOS diode module according to claim 1 or the NMOS diode module according to claim 2, and the second and fourth diode modules each is constructed by the PMOS diode module according to claim 1 or the NMOS diode module according to claim 2.

The rectifier circuit further comprises a switch control unit switching switching states of switches in the first to fourth diode modules when a voltage of the output terminal is equal to or greater than a predetermined value.

In accordance with another embodiment of the present invention, a rectifier circuit comprising: a plurality of rectifier circuits according to claim 3 cascade-connected, wherein among the plurality of rectifier circuits, a ground voltage terminal of a rectifier circuit of the lowest state is grounded, a load capacitor is connected to an output terminal of a rectifier circuit of the highest stage, and

storage capacitors are connected between ground voltage terminals and output terminals of the plurality of rectifier circuits.

The rectifier circuit further comprises a switch control unit switching switching states of switches in the diode modules in the plurality of rectifier circuits when a voltage of the output terminal of the rectifier circuit of the highest stage is equal to or greater than a predetermined value.

In claim 1 of the present invention, a threshold voltage may be reduced using an output voltage without using a power source in a diode module.

In claim 2 of the present invention, a threshold voltage may be reduced using an output voltage without using a power source in a diode module.

In claim 3 of the present invention, rectification efficiency reduction due to a threshold voltage cannot be reduced in a rectifier circuit.

In claim 4 of the present invention, an output voltage of a rectifier circuit is equal to or greater than a predetermined value, a threshold voltage of a diode may be automatically reduced.

In claim 5 of the present invention, since a rectifier circuit is cascade-connected, an output voltage may be increased.

In claim 6 of the present invention, an output voltage of a rectifier circuit is equal to or greater than a predetermined value, a threshold voltage of a diode may be automatically reduced to improve rectification efficiency.

### BRIEF DESCRIPTION OF THE DRAWINGS

The objects, features and advantages of the present invention will be more apparent from the following detailed description in conjunction with the accompanying drawings, in which:

FIG. 1 is a circuitry diagram illustrating a conventional half wave rectifier;

FIG. 2 is a view illustrating relationship between an input voltage and an output voltage of a conventional full wave rectifier;

FIG. 3 is a circuitry diagram illustrating a conventional half wave rectifier;

FIG. 4 is a view illustrating a PMOS diode module in accordance with an embodiment of the present invention;

FIG. 5 is a view illustrating an NMOS diode module in accordance with an embodiment of the present invention;

FIG. 6 is a circuitry diagram illustrating a half wave rectifier circuit in accordance with an embodiment of the present invention;

FIG. 7 is a circuitry diagram illustrating an example of a full wave rectifier circuit in accordance with an embodiment of the present invention;

FIG. 8 is a circuitry diagram illustrating another example of a full wave rectifier circuit in accordance with an embodiment of the present invention;

FIG. 9 is a view illustrating an example of a full wave rectifier circuit in accordance with an embodiment of the present invention;

FIG. 10 is a circuitry diagram illustrating an example of a POR circuit;

FIG. 11 is a view illustrating another example of a full wave rectifier circuit in accordance with an embodiment of the present invention;

FIG. 12 is a view illustrating effects of a rectifier circuit in accordance with an embodiment of the present invention;

FIG. 13 is a view illustrating test results of a full wave rectifier circuit in accordance with an embodiment of the present invention; and

FIG. 14 is a view illustrating a test result of a full wave rectifier circuit in accordance with an embodiment of the present invention.

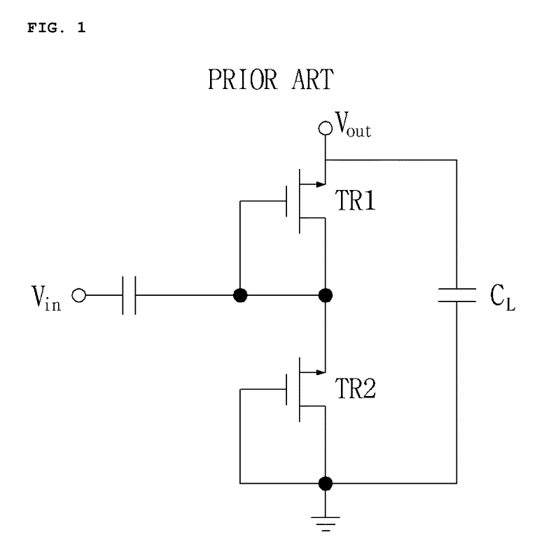

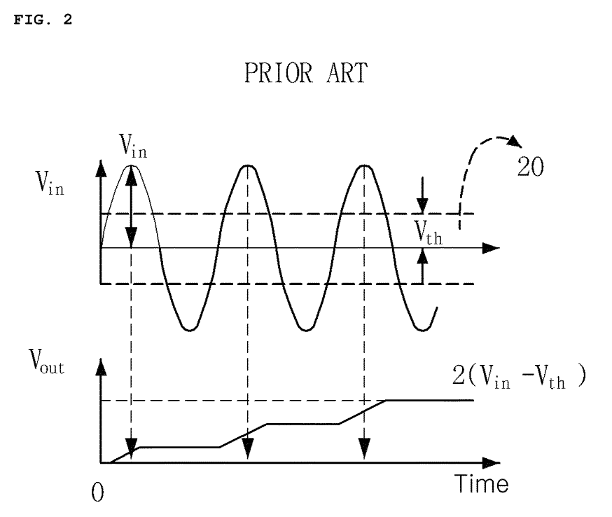

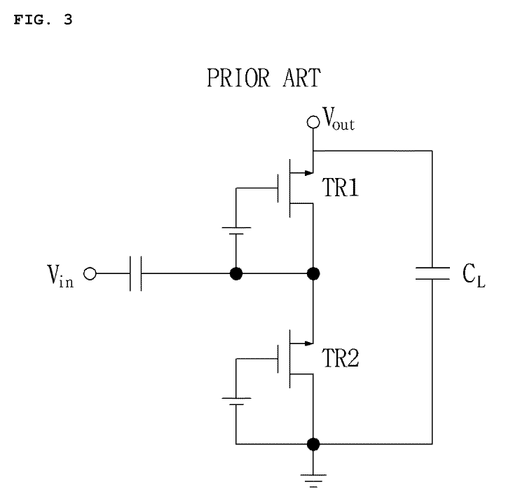

### DETAILED DESCRIPTION OF EXEMPLARY EMBODIMENTS

Hereinafter, exemplary embodiments of the present invention are described in detail with reference to the accompanying drawings. The use of the same reference number throughout the several figures designates a like or similar element.

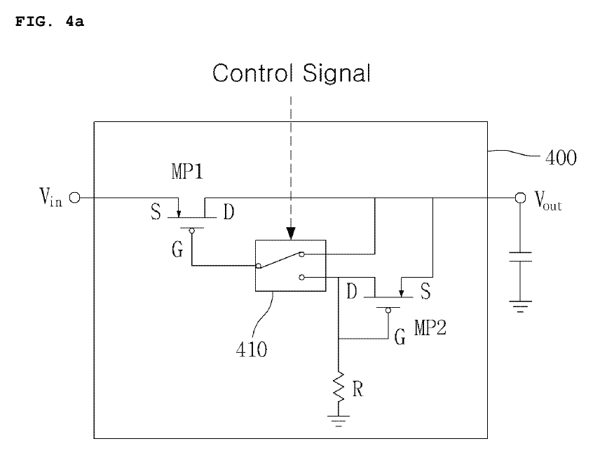

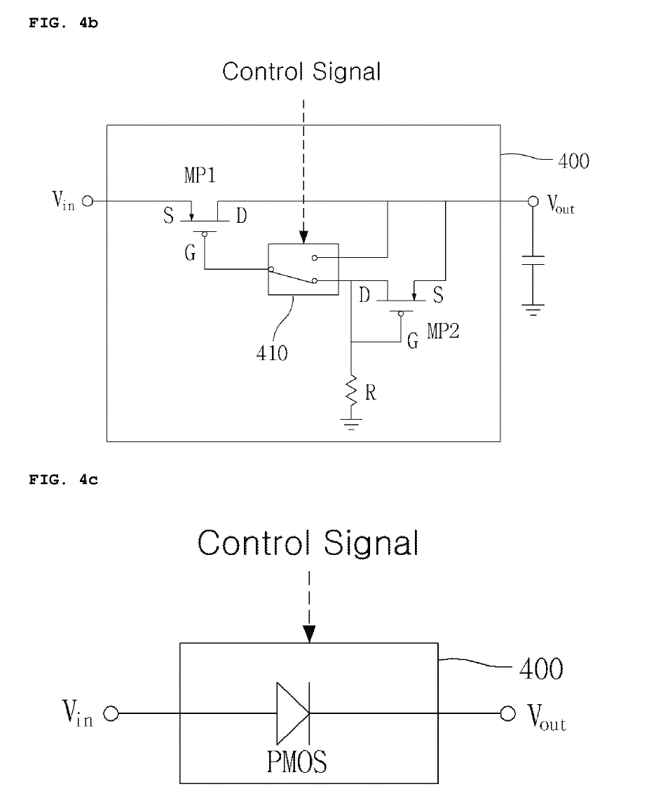

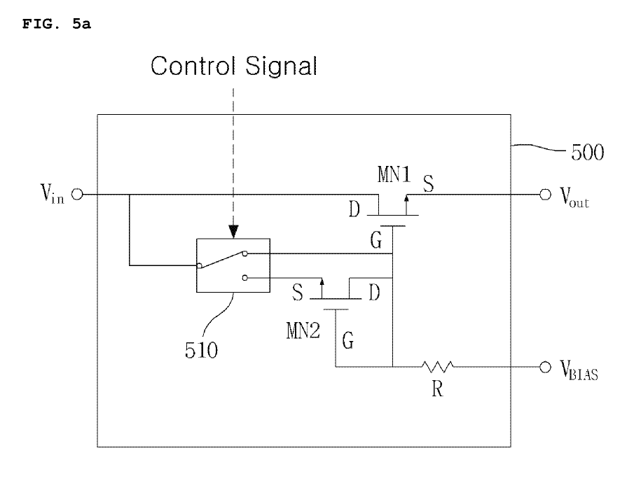

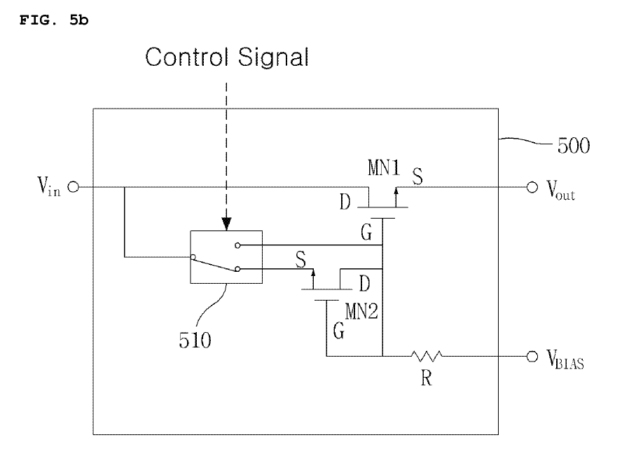

FIGS. 4 and 5 are views illustrating diode modules of a rectifier circuit in accordance with an embodiment of the present invention, respectively. FIG. 4 is a view illustrating a diode module 400 using a PMOS transistor.

In order to operate the rectifier circuit according to the present invention, an input voltage should be greater than a threshold voltage of a diode-connected transistor. Meanwhile, after the diode-connected transistor is turned-on, the input voltage may be less than the threshold voltage of the diode-connected transistor. The reason is because the threshold voltage of the diode-connected transistor was previously compensated for.

When a voltage input to an input terminal Vᵢₙ is equal to or greater than a predetermined value |Vₜₕₚ|, a PMOS diode module 400 becomes a state that may flow an electric current from the input terminal Vᵢₙ to an output terminal Vₒᵤₜ. The PMOS diode module 400 includes a first PMOS transistor MP1 with a source and a drain respectively connected to the input terminal Vᵢₙ and the output terminal Vₒᵤₜ, and a second PMOS transistor MP2 with a source connected to the output terminal Vₒᵤₜ and a gate and a drain connected to each other. The PMOS diode module 400 further includes a switch 410 and a bias resistor R. The switch 410 connects a gate of the first PMOS transistor MP1 to one of the output terminal Vₒᵤₜ and a drain of the second PMOS transistor MP2. One terminal of the bias resistor R is connected to the gate of the second PMOS transistor MP2, and a bias voltage is applied to another terminal of the resistor R. In this case, the another terminal of the bias resistor R may be grounded.

Referring to FIG. 4(a), when the gate of the first PMOS transistor MP1 is connected to the output terminal Vₒᵤₜ, the first PMOS transistor MP1 is diode-connected. When a voltage difference between the gate and the source of the first PMOS transistor MP1 is equal to or greater than |Vₜₕₚ|, the first PMOS transistor MP1 is turned-on to flow an electric current from the input terminal Vᵢₙ to the output terminal Vₒᵤₜ. Accordingly, in this case, a voltage of the output terminal Vₒᵤₜ becomes less than that of the input terminal Vᵢₙ by |Vₜₕₚ|.

When the voltage of the output terminal Vₒᵤₜ becomes high enough to turn-on the second PMOS transistor MP2, as shown in FIG. 4(b), a control signal is applied to a switch 410 to be switch, so that the switch 410 connects the gate of the first PMOS transistor MP1 to the drain of the second PMOS transistor MP2. Accordingly, a voltage difference between the gate and the source of the second PMOS transistor MP2 becomes equal to or greater than |Vₜₕₚ| and because a gate of the second PMOS transistor MP2 is connected to a drain thereof, the voltage of the output terminal Vₒᵤₜ becomes higher than a gate voltage of the first PMOS transistor MP1 by |Vₜₕₚ|. Consequently, when the first PMOS transistor MP1 is in a conducting state, a voltage of the input terminal Vᵢₙ can be transferred to the output terminal Vₒᵤₜ without voltage drop. FIG. 4(c) shows an equivalent model of a PMOS diode module 400.

FIG. 5 is a view illustrating a diode module 500 using an NMOS transistor. When a voltage input through the input terminal Vᵢₙ in an NMOS diode module 500 is equal to or greater than a predetermined reference value |Vₜₕₙ|, it becomes a state capable of flowing an electric current from the input terminal Vᵢₙ to the output terminal Vₒᵤₜ. An NMOS diode module 500 includes a first NMOS transistor MN1 with a drain and a source respectively connected to an input terminal Vᵢₙ and an output terminal Vₒᵤₜ, and a second NMOS transistor MN2 with a drain connected to the gate of the first NMOS transistor MN1. A gate and the drain of the second NMOS transistor MN2 are connected to each other. The NMOS diode module 500 further includes a switch 510 and a bias resistor R. The switch 510 connects the input terminal Vᵢₙ to one of the gate of the first NMOS transistor MN1 and a drain of the second NMOS transistor MN2. One terminal of the bias resistor R is connected to the gate of the second NMOS transistor MN2, and a bias voltage is applied to another terminal of the bias resistor R.

Referring to FIG. 5(a), when the input terminal Vᵢₙ is connected to the gate of the first NMOS transistor MN1, the first NMOS transistor MN1 is diode-connected. When a voltage difference between the gate and the source of the first NMOS transistor MN1 is equal to or greater than |Vₜₕₙ|, the first NMOS transistor MN1 is turned-on to flow an electric current from the input terminal Vᵢₙ to the output terminal Vₒᵤₜ. Accordingly, at this time, a voltage of the output terminal Vₒᵤₜ becomes less than that of the input terminal Vᵢₙ by |Vₜₕₙ|.

When the bias voltage V_{BIAS} applied to the gate of the second NMOS transistor MN2 through the bias resistor R becomes high enough to turn-on the second NMOS transistor MN2, as shown in FIG. 5(b), a control signal is applied to a switch 510 to be switched, so that the switch 510 connects the source of the second NMOS transistor MN2 to the input terminal Vᵢₙ. Accordingly, a voltage difference between the gate and the source of the second NMOS transistor MN2 becomes equal to or greater than |Vₜₕₙ|. Consequently, when the first NMOS transistor MN1 is in a conducting state, a voltage of the input terminal Vᵢₙ can be transferred to the output terminal Vₒᵤₜ without a voltage drop. FIG. 5(c) shows an equivalent model of a PMOS diode module 500.

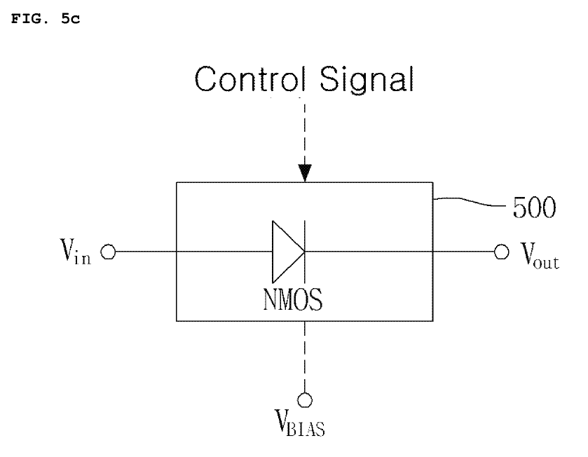

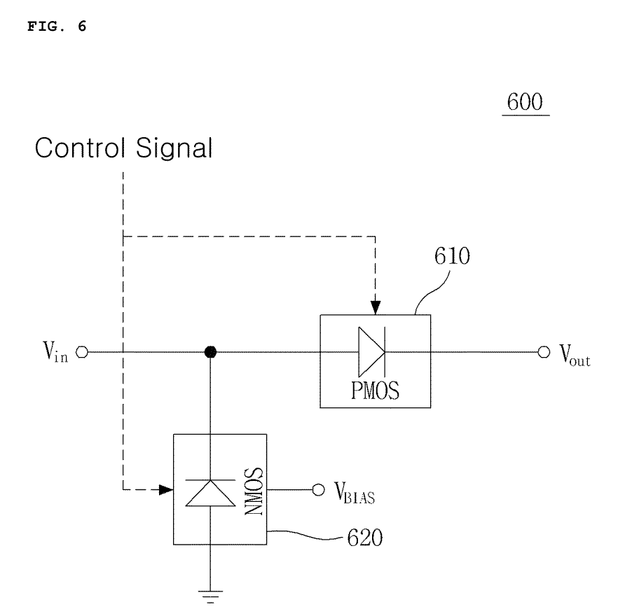

FIG. 6 is a circuitry diagram illustrating a half wave rectifier circuit 600 in accordance with an embodiment of the present invention.

The half wave rectifier circuit 600 includes a first diode module 610, a second diode module 620, and a load capacitor C_{L}. An input terminal of the first diode module 610 functions an input terminal Vᵢₙ of the half wave rectifier circuit 600. An output terminal of the first diode module 610 functions as an output terminal Vₒᵤₜ of the half wave rectifier circuit 600. An input terminal of the second diode module 620 is grounded, and an output terminal of the second diode module 620 is connected to the input terminal of the first diode module 610. One terminal of the load capacitor C_{L}is connected to the output terminal of the first diode module 610, and another terminal of the load capacitor C_{L}is grounded. When the first diode module 610 and the second diode module 620 operates as a general diode, this circuit operates as a half rectifier circuit. In the present invention, the forgoing PMOS diode module 400 or NMOS diode module 500 may be used as the first diode module 610. The forgoing PMOS diode module 400 or NMOS diode module 500 may be used as the second diode module 620. Although FIG. 6 shows a case that the first diode module 610 is the PMOS diode module 400, the first diode module 610 may be the NMOS diode module 500. When the second diode module 620 is the NMOS diode module 500, a bias voltage should be applied thereto to turn-on the second NMOS transistor MN2 of FIG. 5.

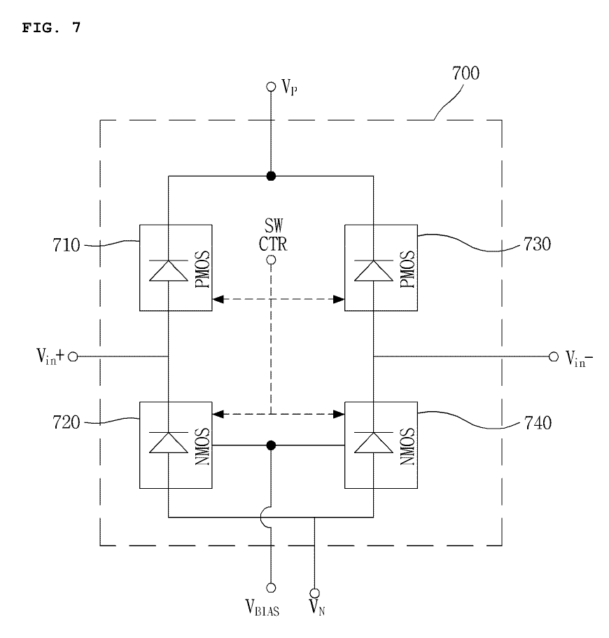

FIG. 7 is a circuitry diagram illustrating an example of a full wave rectifier circuit 700 in accordance with an embodiment of the present invention.

AC signals (differential signals) having phases inverted to each other, namely, phase difference of 180 degrees from each other are input to a first input terminal Vᵢₙ₊ and a second input terminal Vᵢₙ₋ of the full wave rectifier circuit 700. The full wave rectifier circuit 700 includes a first diode module 710, a second diode module 720, a third diode module 730, a fourth diode module 740. The first and third diode modules 710 and 730 may be the PMOS diode module 400 of FIG. 4 or the NMOS diode module 500 of FIG. 5. Further, the second and fourth diode modules 720 and 740 may be the PMOS diode module 400 of FIG. 4 or the NMOS diode module 500 of FIG. 5. In the present embodiment, the PMOS diode module 400 of FIG. 4 is used as the first and third diode modules 710 and 730. The NMOS diode module 500 of FIG. 5 is used as the second and fourth diode modules 720 and 740. An input of the first diode module 710 functions as the first input terminal Vᵢₙ₊, and an input of the third diode module 730 functions as a the second input terminal Vᵢₙ₋. An output of the first diode module 710 and an output of the third diode module 730 are connected to each other, and function as an output terminal V_{P} of the full wave rectifier circuit 700. An input of the second diode module 720 and an input of fourth diode module 740 are connected to each other, which function as a ground voltage terminal V_{N} of the full wave rectifier circuit 700. An output of the second diode module 720 is connected to the input of the first diode module 710. An output of the fourth diode module 740 is connected to the input of the third diode module 730. A bias voltage is applied to the second diode module 720 and the fourth diode module 740. The bias voltage is also applied to the second NMOS transistor MN2 of the NMOS diode module 500 shown in FIG. 5 through a bias resistor R.

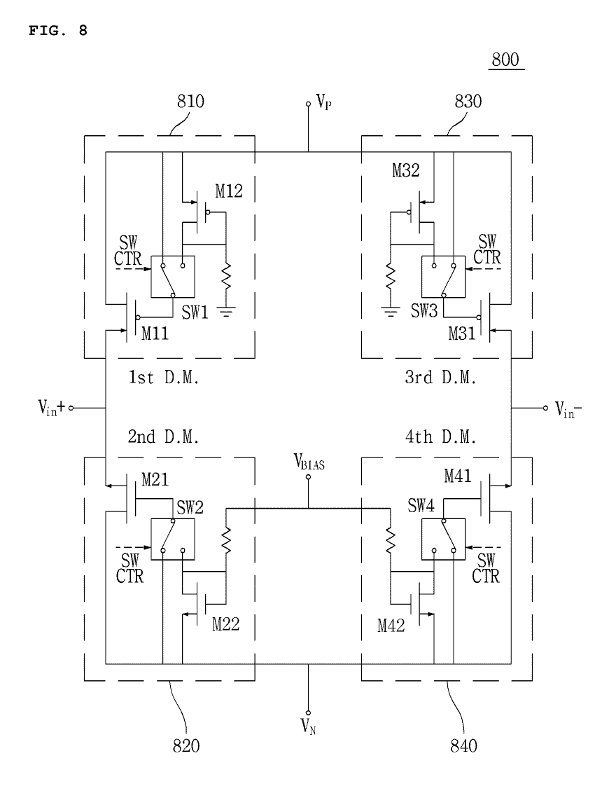

FIG. 8 is a circuitry diagram illustrating another example of a full wave rectifier circuit 800 in accordance with an embodiment of the present invention, which is a detailed construction of the full wave rectifier circuit 700 shown in FIG. 7.

The full wave rectifier circuit 800 includes a first diode module 810, a second diode module 820, a third diode module 830, and a fourth diode module 840. The first, second, third, and fourth diode modules 810, 820, 830, and 840 are detailed constructions of the first, second, third, and fourth diode modules 710, 720, 730, and 740 of FIG. 7, respectively. Because connection relationships between respective diode modules 810, 820, 830, and 840, and input/output terminals V_{P}, V_{N}, and V_{BIAS} can be clearly understood, the detailed description thereof is omitted. Moreover, a detailed construction and operation of the diode modules 810, 820, 830, and 840 were described with reference to FIG. 4 and FIG. 5, and thus the detailed description thereof is appropriately omitted.

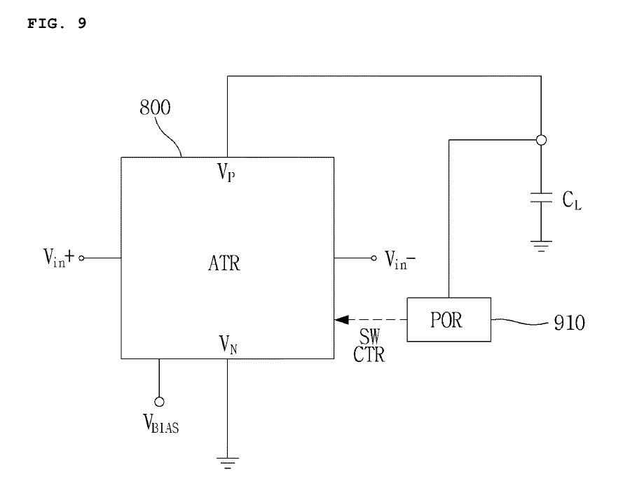

FIG. 9 is a view illustrating an example of a full wave rectifier circuit 800 shown in FIG. 8.

A ground voltage terminal V_{N} of the full wave rectifier circuit 800 is grounded, and the load capacitor C_{L} is connected to the output terminal V_{P}. A voltage capable of turning-on NMOS transistors included in the full wave rectifier circuit 800, namely, a voltage greater than that of the ground voltage terminal by at least Vₜₕₙ, is applied to the bias voltage terminal V_{BIAS}. When sine waves having a phase difference of 180 degrees are input through input terminals Vᵢₙ₊ and Vᵢₙ₋, the load capacitor C_{L} is charged with a predetermined charge, thereby increasing an output voltage, that is, a voltage of the output terminal V_{P}. If a switch continues to stay in a position of FIG. 8, when an amplitude of an input voltage is Vᵢₙ, a maximum value of an output DC voltage is 2(Vᵢₙ−Vₜₕ)

In the present invention, when a voltage of the output terminal V_{P} is equal to or greater than a predetermined value, positions of switches SW1, SW2, SW3, and SW4 change. When the full wave rectifier circuit 800 starts to operate, respective switches SW1, SW2, SW3, and SW4 operate to connect drains and gates of first transistors M11, M21, M31, and M41 of the first, second, third, and fourth diode modules 810, 820, 830, and 840 to each other. During operations of the switches SW1, SW2, SW3, and SW4, when the voltage of the output terminal V_{P} is equal to or greater than a predetermined value, the respective switches SW1, SW2, SW3, and SW4 are switched to connect respective gates of the first transistors M11, M21, M31, and M41 of the first, second, third, and fourth diode modules 810, 820, 830, and 840 to respective gates of second transistors M12, M22, M32, and M42 of the first, second, third, and fourth diode modules 810, 820, 830, and 840. A time when the voltage of the output terminal V_{P} is equal to or greater than a voltage capable of turning-on a second transistor M12 of the first diode module 810 and a second transistor M22 of the second diode module 820 can be selected as a switch time of the switches SW1, SW2, SW3, and SW4. Accordingly, the present invention includes a switch controller 910 outputting a switch control signal SW CRT when the voltage of the output terminal V_{P} is equal to or greater than a predetermined voltage. The switch controller 910 may be a power-on-reset (POR) circuit.

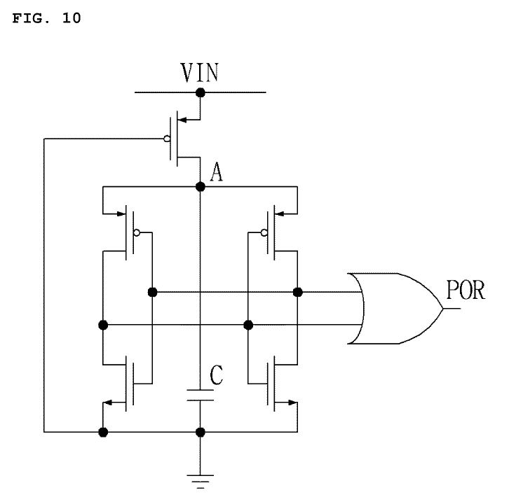

FIG. 10 is a circuitry diagram illustrating an example of a POR circuit 910.

While a value of Vᵢₙ is increased, when it becomes greater than a specific value, a POR value is changed from 0 to 1. A value of Vᵢₙ can be selected by appropriately adjusting C value when the POR value is changed from 0 to 1. An operation of the POR circuit 910 is described in J.-P. Curty, M. Declercq, C. Dehollain, N. Joehl, “Design and Optimization of Passive UHF RFID Systems” P. 103 (Springer 2007) in detail.

Referring back to FIG. 8 and FIG. 9, the switches SW1, SW2, SW3, and SW4 are switched according to an output voltage such that an output DC voltage up to 2 Vᵢₙ can be theoretically obtained.

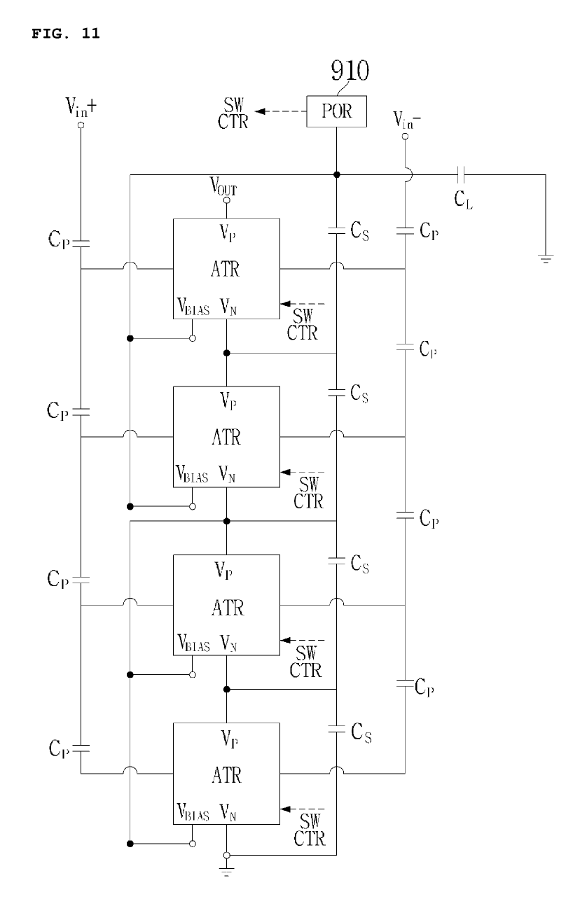

FIG. 11 is a view illustrating another example of a full wave rectifier circuit 800 shown in FIG. 8.

Four full wave rectifier circuits 800-1, 800-2, 800-3, and 800-4 are cascade-connected. The constructions of full wave rectifier circuits 800-1, 800-2, 800-3, and 800-4 are identical with that of the full wave rectifier circuit 800 shown in FIG. 8. The cascade-connection between the full wave rectifier circuits 800-1, 800-2, 800-3, and 800-4 means that an output terminal V_{P} of the first full wave rectifier circuit 800-1 is connected to a ground voltage terminal V_{N} of the second full wave rectifier circuit 800-2, an output terminal V_{P} of the second full wave rectifier circuit 800-2 is connected to a ground voltage terminal V_{N} of the third full wave rectifier circuit 800-3, and an output terminal V_{P} of the third full wave rectifier circuit 800-3 is connected to a ground voltage terminal V_{N} of the fourth full wave rectifier circuit 800-4. Among the cascade-connected full wave rectifier circuits, a full wave rectifier circuit of the lowest stage, namely, a ground voltage terminal V_{N} of the first full wave rectifier circuit 800-1 is grounded. A full wave rectifier circuit of the highest stage, namely, an output terminal V_{P} of the fourth full wave rectifier circuit 800-4 is connected to a load capacitor C_{L}. A voltage capable of turning-on NMOS transistors included in respective full wave rectifier circuits 800-1, 800-2, 800-3, and 800-4 is applied to bias voltage terminals V_{BIAS} of the full wave rectifier circuits 800-1, 800-2, 800-3, and 800-4.

In the present embodiment, the output terminal V_{P} of the second full wave rectifier circuit 800-2 is connected to the bias voltage terminals V_{BIAS} of the first and second full wave rectifier circuits 800-1 and 800-2. The output terminal V_{P} of the fourth full wave rectifier circuit 800-4 is connected to the bias voltage terminals V_{BIAS} of the third and fourth full wave rectifier circuits 800-3 and 800-4. This is described by way of example only. The output terminal V_{P} of the fourth full wave rectifier circuit 800-4 may be connected to the bias voltage terminals V_{BIAS} of the first to fourth full wave rectifier circuits 800-1, 800-2, 800-3, and 800-4. Storage capacitors C_{S} are connected between respective output terminals V_{P} and respective ground voltage terminals V_{N} of respective full wave rectifier circuits 800-1, 800-2, 800-3, and 800-4. The storage capacitors C_{S} are charged with a charge to sequentially increase outputs of respective full wave rectifier circuits 800-1, 800-2, 800-3, and 800-4. When sine waves having a phase difference of 180 degrees are input through input terminals Vᵢₙ₊ and Vᵢₙ₋ of the first to fourth full wave rectifier circuits 800-1, 800-2, 800-3, and 800-4, the load capacitor C_{L} is charged with a predetermined charge.

In the present invention, when a voltage of an output terminal V_{P} of the fourth full wave rectifier circuit 800-4, that is, a voltage across the load capacitor C_{L} is equal to or greater than a predetermined value, positions of switches of respective full wave rectifier circuits 800-1, 800-2, 800-3, and 800-4 change. When the full wave rectifier circuit 800 starts to operate, respective switches SW1, SW2, SW3, and SW4 operate to connect drains and gates of first transistors M11, M21, M31, and M41 of the first, second, third, and fourth diode modules 810, 820, 830, and 840 of FIG. 8 to each other.

During operations of the switches SW1, SW2, SW3, and SW4, when the voltage of the output terminal V_{P} is equal to or greater than a predetermined value, the respective switches SW1, SW2, SW3, and SW4 are switched to connect respective gates of the first transistors M11, M21, M31, and M41 of the first, second, third, and fourth diode modules 810, 820, 830, and 840 to respective gates of second transistors M12, M22, M32, and M42 of the first, second, third, and fourth diode modules 810, 820, 830, and 840. A time when the voltage of the output terminal V_{P} is equal to or greater than a voltage capable of turning-on a second transistor M12 of the first diode module 810 and a second transistor M22 of the second diode module 820 of the respective full wave rectifier circuits 800-1, 800-2, 800-3, and 800-4 can be selected as a switch time of the switches SW1, SW2, SW3, and SW4. Accordingly, the present invention includes a POR circuit 910 outputting a switch control signal SW CRT when the voltage of the output terminal V_{P} is equal to or greater than a predetermined voltage.

Although it was described in FIG. 11 that sine waves having a phase difference of 180 degrees are input through input terminals Vᵢₙ₊ and Vᵢₙ₋ of the first to fourth full wave rectifier circuits 800-1, 800-2, 800-3, and 800-4 through a pumping capacitor C_{P}, the pumping capacitor C_{P} can be eliminated. Namely, capacitance of the pumping capacitor C_{P} may be infinite (both terminals of the pumping capacitor C_{P} are short-circuited). If the capacitance of the pumping capacitor C_{P} is finite, it prevents a charge stored in a load capacitor C_{L} and a storage capacitor C_{S} to be discharged to an input terminal.

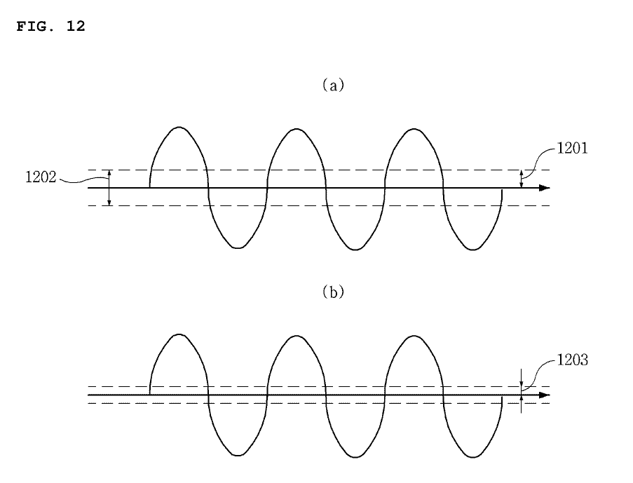

FIG. 12 is a view illustrating effects of a rectifier circuit in accordance with an embodiment of the present invention.

FIG. 12(a) is a graph showing a dead zone 1002, which cannot be used to increase a charge voltage of a load capacitor due to a turning-on voltage Vₜ (1201) of a transistor included in a conventional rectifier circuit when a sine wave is input to the rectifier circuit.

FIG. 12(b) is a graph illustrating reduction of the dead zone by reducing a turning-on voltage to Vₜ−V_{tb} (1023) in the rectifier circuit according to the present invention. In this case, in the rectifier circuit of the present invention, rectification efficiency may be improved and an output voltage may be increased.

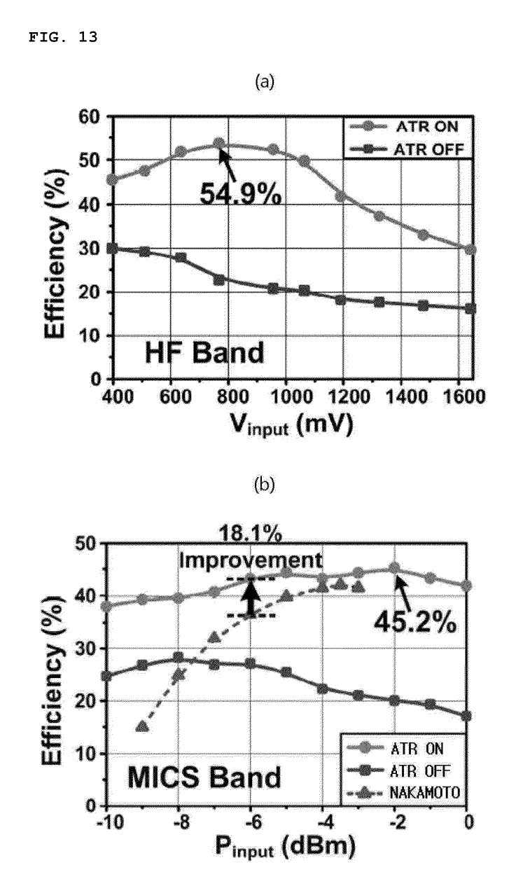

FIG. 13 is a view illustrating test results of a full wave rectifier circuit in accordance with an embodiment of the present invention.

A rectifier circuit was manufactured using 0.18 μm 1P6M standard CMOS process. It was measured that respective rectifier peak efficiencies for HF and MICS bands are 54.9% and 45.2%, respectively.

Since the rectifier circuit of the present invention uses ART, rectification efficiency is improved by 18.1% in comparison with a prior art that a ferroelectric capacitor is used in an input of 6 dBm. A result of the prior art using the ferroelectric capacitor is provided from a patent reference disclosed in H. Nakamoto, et al., “passive UHF RFID Tag LSI with 36.6% Efficiency CMOS-Only Rectifier and Current-Mode Demodulator in 0.35 μm FeRAM Technology,” ISSCC Dig. Tech. Papers, pp. 310-311, February 2006.

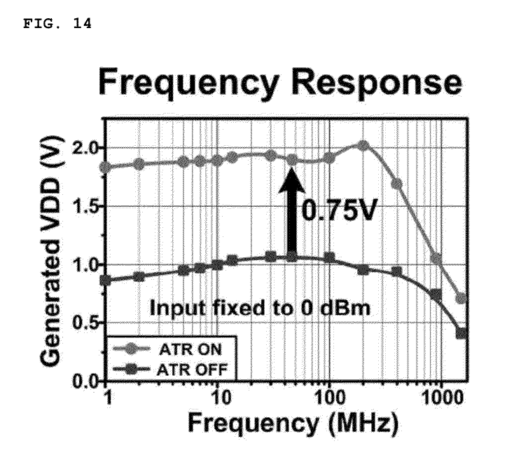

FIG. 14 is a view illustrating a test result of a full wave rectifier circuit in accordance with an embodiment of the present invention.

Referring to FIG. 14, a DC voltage generated by a rectifier circuit according to the present invention is equal to or greater than about 1.8V at a frequency of 200 MHz, but is rapidly reduced to approximately 1.0V at a frequency of 1 GHz. Since the rectifier circuit uses the ART, a DC voltage output is increased by about 0.75V.

In general, the efficiency and sensitivity are important performance factors in the rectifier circuit. The present invention may improve the efficiency of performance factors in the rectifier circuit. Accordingly, the present invention is effective in a case of improving the efficiency of the rectifier circuit through a CMOS process of a low cost.

Although embodiments in accordance with the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A PMOS diode module flowing a forward current from an input terminal to an output terminal comprising:
a first PMOS transistor including a source connected to the input terminal, and a drain connected to the output terminal;
a second PMOS transistor including a source connected to the output terminal, and a gate and a drain connected to each other;
a switch connecting the gate of the first PMOS transistor to one of the output terminal and the drain of the second PMOS transistor; and
a bias resistor including one terminal connected to the gate of the second PMOS transistor and another terminal to which a bias voltage is applied.

2. An NMOS diode module flowing a forward current from an input terminal to an output terminal comprising:
a first NMOS transistor including a drain connected to the input terminal, and a source connected to the output terminal;
a second NMOS transistor including a drain connected to the gate of the first NMOS transistor, and a gate and a drain connected to each other;
a switch connecting the gate of the first PMOS transistor to one of the output terminal and the drain of the second NMOS transistor; and
a bias resistor including one terminal connected to the gate of the second NMOS transistor and another terminal to which a bias voltage is applied.

3. A rectifier circuit receiving and rectifying differential signals through a first input terminal and a second terminal, and outputting the rectified differential signals to an output terminal, comprising:
first to fourth diode modules each including an input terminal, an output terminal, and a control input terminal,
wherein the output terminal of the second diode module is connected to the input terminal of the first diode module,
the output terminal of the fourth diode module is connected to the input terminal of the third diode module,
the input terminal of the first diode module is connected to the first input terminal,
the input terminal of the third diode module is connected to the second input terminal,
the output terminal of the first diode module and the output terminal of the third diode module are connected to the output terminal of the rectifier circuit,
the input terminal of the second diode module and the input terminal of the fourth diode module are connected to each other to constitute a ground voltage terminal,
the first and third diode modules each is constructed by the PMOS diode module according to claim 1 or the NMOS diode module according to claim 2, and
the second and fourth diode modules each is constructed by the PMOS diode module according to claim 1 or the NMOS diode module according to claim 2.

4. The rectifier circuit according to claim 3, further comprising a switch control unit switching switching states of switches in the first to fourth diode modules when a voltage of the output terminal is equal to or greater than a predetermined value.

5. A rectifier circuit comprising:
a plurality of rectifier circuits according to claim 3 cascade-connected, wherein
among the plurality of rectifier circuits, a ground voltage terminal of a rectifier circuit of the lowest state is grounded,
a load capacitor is connected to an output terminal of a rectifier circuit of the highest stage, and
storage capacitors are connected between ground voltage terminals and output terminals of the plurality of rectifier circuits.

6. The rectifier circuit according to claim 5, further comprising a switch control unit switching switching states of switches in the diode modules in the plurality of rectifier circuits when a voltage of the output terminal of the rectifier circuit of the highest stage is equal to or greater than a predetermined value.
